(19) United States
(12) Patent Application Publication
(10) Pub. No.: US 2024/0303306 A1
(43) Pub. Date: Sep. 12, 2024

(54) SYSTEMS AND METHODS FOR SIGNATURE AUTHENTICATION

(71) Applicant: Wells Fargo Bank, N.A., San Francisco, CA (US)

(72) Inventors: Himanshu Baral, Fremont, CA (US); Tapan Totla, Bangalore (IN)

(21) Appl. No.: 18/180,433

(22) Filed: Mar. 8, 2023

(51) Int. Cl. G06F 21/32; G06F 21/33

(52) U.S. Cl. CPC G06F 21/32; G06F 21/33

(57) ABSTRACT

Systems, apparatuses, methods, and computer program products are disclosed for performing signature authentication. An example method includes: obtaining a sample signature of an individual; generating a predetermined number of variant signatures using the sample signature; causing the predetermined number of variant signatures to be presented to the individual; receiving a selection from the individual where the selection includes one or more of the predetermined number of variant signatures presented to the individual; receiving a request from the individual where the request includes a request-authentication-use signature;

authenticating the individual by comparing the request-authentication-use signature to the selection; and permitting or rejecting the request based on a result of the authenticating.

### BACKGROUND

Computing devices may provide various services. Computing devices may also be trained to automatically provide such services without human intervention.

### BRIEF SUMMARY

Fraud prevention has long been a critical concern for businesses and individuals alike. Fraudulent activities such as identity theft, financial scams, and cyber-attacks can have devastating consequences for victims, including financial losses, reputational damage, and legal repercussions. In recent years, the prevalence and sophistication of fraud schemes have continued to grow, driving the need for more advanced and effective fraud prevention measures. Today, fraud prevention encompasses a broad range of technologies and strategies, including data analytics, machine learning, biometrics, and behavioral analysis. These tools are used by businesses, financial institutions, and government agencies to detect and prevent fraudulent activities in real-time. While significant progress has been made in this field, the ongoing evolution of fraud tactics means that continued investment and innovation will be necessary to stay ahead of the threat.

Additionally, existing fraud detection technologies are known to have several limitations (in particular, in the verification of digital and/or physical written signatures). More specifically, as a result of human error, no two physical written signatures (e.g., wet signatures) produced by an individual are completely identical. These slight variations are taken into account when such signatures are authenticated, which enables bad actors (e.g., con artists, forgers, or the like) to more easily reproduce (e.g., forge) these written signatures. Similarly, the rise of generative AI has resulted in deepfake technology that allows these bad actors to also reproduce not only an individual's voice but also the individual's likeness (e.g., image). As a result, it has become increasingly difficult to authenticate an individual without adding an additional layer of security to account for the above-identified limitations in detecting signature forgeries.

In contrast to current methods for signature authentication, one or more embodiments herein disclose an authentication method that adds such an additional layer of security to enable an individual to create an identity that is not as easily forged and/or stolen. In particular, one or more embodiments disclosed herein combine the use of various machine learning and artificial intelligence techniques (as discussed in more detail below in reference to FIG. 3) to allow individuals to choose and/or create variations (e.g., variations in the individuals' written signature) that are acceptable to the individuals. Because only the individuals are aware of the chosen and/or created variations, it becomes more difficult for bad actors to steal (e.g., forge) and use these individuals' identities. As a result, one or more embodiments disclosed herein provide a direct improvement in the technical fields of fraud prevention, data security, and data authentication. More specifically, the slight variations in signatures that were once known to be an issue in conventional signature authentication techniques are now used instead toward the customer's benefit by having customers authenticate such variations so that entities (e.g., banks, service providers, etc.) can understand the salient features of each customer's signature. As a result, when customers submit their signature (e.g., on checks or other documents), such entities are able to more accurately validate these received signatures since multiple customer authorized signatures are available within the entities' repository.

More specifically, in some embodiments, three notions for creating a strong identity are used. These three notions include: something that an individual knows (e.g., a password), something that an individual has (e.g., a digital and/or physical certificate, an identification card, or the like), and something that the individual is (e.g., the individual's image, voice, written imprint, biological imprint, or the like). Applying all three notions in combination for authenticating an individual creates for a secure authentication system that would be difficult for bad actors to crack, which results in further improvements in the technical fields of fraud prevention, data security, and data authentication.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a device that may perform various operations in accordance with some example embodiments described herein.

FIG. 3 illustrates an example flowchart for performing signature authentication, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

In the context of one or more embodiments disclosed herein, the term “signature” by itself refers to “a distinctive pattern, product, or characteristic by which someone or something can be identified,” and should not be limited to a specific type of signature (e.g., a written signature such as a person's name written in a distinctive way as a form of identification in authorizing a check or document or concluding a letter) unless specified (e.g., by having a descriptor coming before the term “signature”). For example, a signature could any one of: written signatures (e.g., a wet signature and/or an electronic/digital version of the wet signature), a voice signature (e.g., a recording of an individual's voice), a video signature (e.g., a recording of an individual's likeness), or the like.

### System Architecture

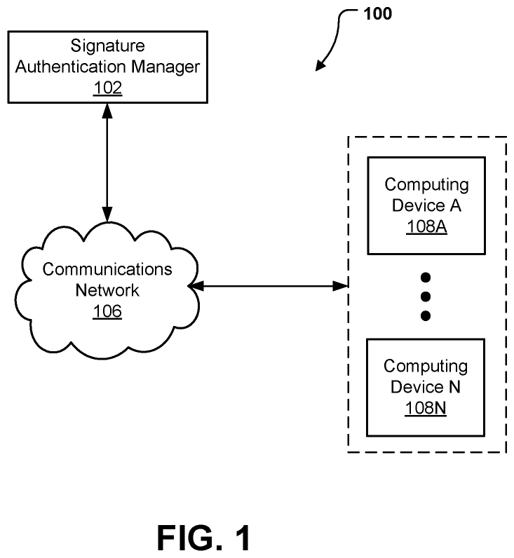

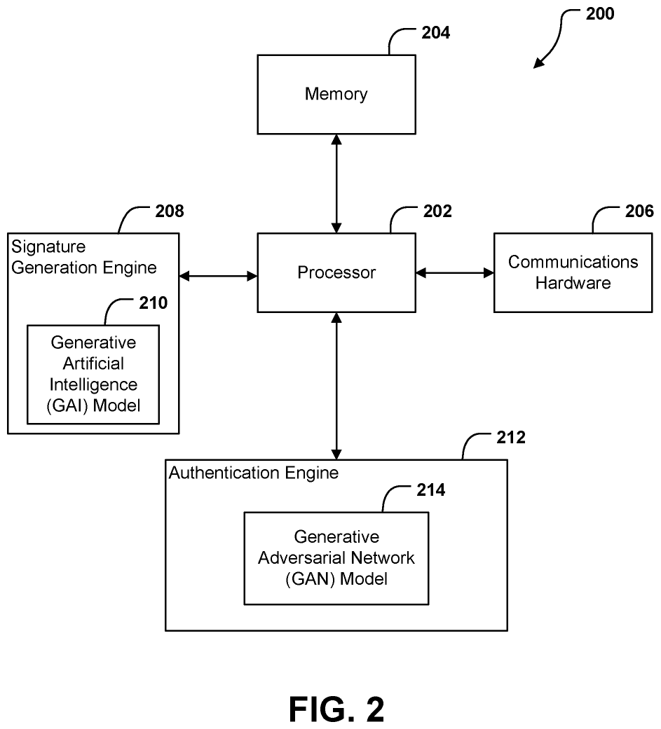

Example embodiments described herein may be implemented using any of a variety of computing devices or servers. To this end, FIG. 1 illustrates an example system 100 within which various embodiments may operate. As illustrated in FIG. 1, the system may include a signature authentication manager 102 that may receive and/or transmit information via communications network 106 (e.g., the Internet) with any number of other devices, such as computing devices 108A-108N. In some embodiments, individuals may directly interact with the signature authentication manager 102 (e.g., via communications hardware 206 of signature authentication manager 102, which is discussed in more detail below in reference to FIG. 2), in which case a separate computing device connected to the signature authentication manager 102 (e.g., in an instance where the signature authentication manager 102 is a server disposed at a location that is not physically accessible to the individual) may not be utilized. Whether by way of direct interaction or via a separate computing device, an individual may communicate with, operate, control, modify, or otherwise interact with the signature authentication manager 102 to perform the various functions and achieve the various benefits described herein.

In some embodiments, signature authentication manager 102 may be implemented as one or more computing devices or servers, which may be composed of a series of components. Particular components of the threat manager are described in greater detail below with reference to apparatus 200 in FIG. 2.

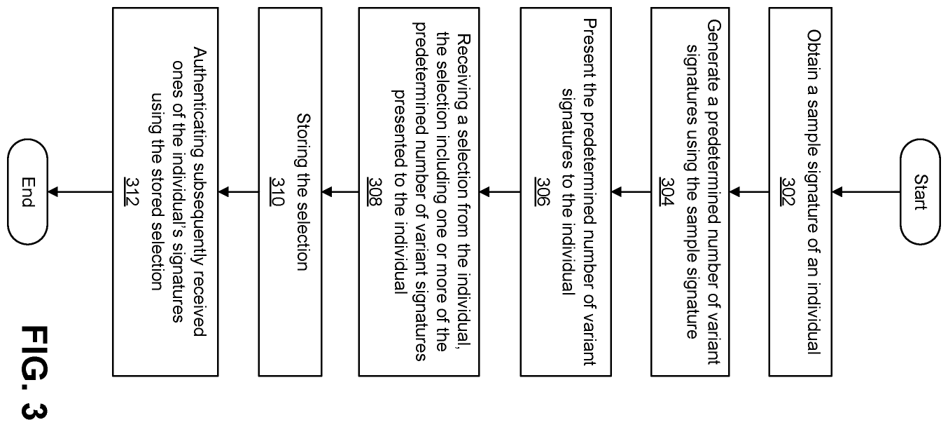

In some embodiments, the computing devices 108A-108N may be embodied by any computing devices known in the art such as desktop or laptop computers, mobile phones (e.g., smart phones), tablets, servers, server devices, or the like. Each of the computing devices 108A-108N need not themselves be independent devices, but may be peripheral devices communicatively coupled to other computing devices. For example, each of the computing devices 108A-108N may be a computing device belonging to an individual (or group) within an organization. As another example, each of the computing devices 108A-108N may be a server provisioned with software enabling the server to provide one or more computing services (e.g., the operations of one or more embodiments discussed in more detail below in reference to the flowchart of FIG. 3).

### Example Implementing Apparatuses

The signature authentication manager 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIG. 3. As illustrated in FIG. 2, the apparatus 200 may include processor 202, memory 204, communications hardware 206, signature generation engine 208, and authentication engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a signature generation engine 208 that is configured to generate one or more signatures using a generative artificial intelligence

(GAI) model 210. The signature generation engine 208 may utilize processor 202, memory 204, or any other hardware component included in the apparatus 200 to perform these operations, as described in connection with FIG. 3 below. The signature generation engine 208 may further utilize communications hardware 206 to gather data from a variety of sources (e.g., any of the computing devices 108A-108N, as shown in FIG. 1), and/or exchange data with an individual (e.g., a user, an administrator, a customer, or the like), and in some embodiments may utilize processor 202 and/or memory 204 to generate one or more signatures using the GAI model 210. Additional details about how the signature generation engine 208 generates signatures and additional details about the GAI model 210 are described below in reference to FIG. 3.

In addition, the apparatus 200 further comprises an authentication engine 212 that is configured to authenticate signatures using a generative adversarial network (GAN) model 214. The authentication engine 212 may utilize processor 202, memory 204, or any other hardware component included in the apparatus 200 to perform these operations, as described in connection with FIG. 3 below. The authentication engine 212 may further utilize communications hardware 206 to gather data from a variety of sources (e.g., any of the computing devices 108A-108N, as shown in FIG. 1), and/or exchange data with a user, and in some embodiments may utilize processor 202 and/or memory 204 to authenticate signatures using the GAN model 214. Additional details about how the authentication engine 212 authenticates signatures and additional details about the GAN model 214 are described below in reference to FIG. 3.

Although components 202-212 are described in part using functional language, it will be understood that the particular implementations necessarily include the use of particular hardware. It should also be understood that certain of these components 202-212 may include similar or common hardware. For example, the signature generation engine 208 and authentication engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the signature generation engine 208 and authentication engine 212 may leverage processor 202, memory 204, or communications hardware 206 as described above, it will be understood that any of the signature generation engine 208 and authentication engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the signature generation engine 208 and authentication engine 212 comprise particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of flowcharts.

### Example Operations

Turning to FIG. 3, an example flowchart is illustrated that contain example operations implemented by example embodiments described herein. The operations illustrated in FIG. 3 may, for example, be performed by the signature authentication manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, signature generation engine 208, authentication engine 212, and/or any combination thereof. It will be understood that user interaction with the signature authentication manager 102 may occur directly via communications hardware 206, or may instead be facilitated by a separate computing device (not shown in the figures) that may have similar or equivalent physical componentry facilitating such user interaction.

Turning to FIG. 3, example operations are shown for performing signature authentication.

As shown by operation 302, the apparatus 200 includes means, such as processor 202, memory 204, communications hardware 206, signature generation engine 208, or the like, for obtaining a sample signature of the individual.

In some embodiments, the sample signature of the individual may be retrieved from any source (e.g., directly from the individual (or someone who received the sample signature from the individual) via communications hardware 206, retrieved from memory 204, or the like). The sample signature may include any combination of an individual's written signature, voice signature, video signature, etc.

In some embodiments, prior to receiving the sample signature, the apparatus 200 may transmit (e.g., using communications hardware) a set of instructions for guiding the individual in generating the sample signature. The set of instructions may include any type of content (e.g., list of criteria) that would assist the individual in generating a valid and strong (e.g., unique) signature to be used later for authenticating the individual. For example, the set of instructions may notify the individual to write a predetermined number of instances (e.g., 10, or any other whole number larger than 1) of wet signatures and have the individual select the best-looking wet signature from the predetermined number of instances. As another example, the set of instructions may instruct the individual to clear all sinuses before taking a recording of the individual's voice and playback the recording for the individual to confirm the recording reflects the individual's normal speaking tone. As yet another example, the set of instructions may instruct the individual to strike a specific pose or a specific combination of poses (e.g., face aligned forward, head tilted sidesways toward the left, smile without showing teeth, raise a hand or one or more fingers, hold an object, or the like) when taking a video recording. As yet another example, the set of instructions may instruct the individual to add one or more distinguishing properties/features to the signature (e.g., a longer ending stroke towards the end of a wet signature, dot an “i” or cross a “t” using a different style in a wet signature, use a different pitch and/or tone and/or speak at a different speed for the audio signature, hold an object of sentimental value to the individual, or the like) that only the individual will know that the individual added.

Other types of instructions not described above that would enable an individual to generate a valid and strong (e.g., unique) may be provided without departing from the scope of one or more embodiments disclosed herein. Such addition of the distinguishing properties/features to the signature advantageously allows the individual to produce a signature that will be more difficult (even almost impossible) for a forger to reproduce unless the forger somehow obtains (which is unlikely to happen) information regarding the distinguishing properties/features that were added.

As shown by operation 304, the apparatus 200 includes means, such as processor 202, memory 204, communications hardware 206, signature generation engine 208, or the like, for generating a predetermined number of variant signatures using the sample signature. In some embodiments, the sample signature is fed into the GAI model 210 of the signature generation engine 208 for the GAI model 210 to generate a predetermined number of variant signatures using the sample signature.

In some embodiments, the GAI model 210 may be any type of known GAI model (e.g., Generative Pre-trained Transformer 3 (GPT-3), DALL-E 2, or the like) configured and trained to produce one or more artificial (e.g., man-made) outputs using a provided input (here the sample signature). In some embodiments, the GAI model 210 be configured and trained to add variations (e.g., slight changes) to the provided input. More specifically, the GAI model 210 may use the sample signature as a base and add slight changes to the sample signature while not deviating too much from the original. For example, for a wet signature, the GAI model 210 may be configured and trained to add elements of human error (e.g., imperfections in a stroke caused by a shaking or unstable hand, differences in sizes, or the like). As another example, with voice signatures, the GAI model may be configured and trained to vary the tone and pitch of the recorded voice to simulate audio generated by microphones of varying qualities (e.g., sharper and clearer audio for higher resolution microphones and vice versa). As yet another example, with video signatures, the GAI model may be configured and trained to vary the properties (e.g., resolution, brightness, contrast, or the like) to simulate video generated by cameras of varying qualities. Other types of variations not described above may be added to the original sample signature without departing from the scope of one or more embodiments disclosed herein.

In some embodiments, the predetermined number of variant signatures generated by the GAI model 210 may be any number (namely, any whole number larger than 1) that is set by an owner and/or administrator of the signature authentication manager. For example, only by way of illustration and without limiting one or more embodiments disclosed herein, the GAI model 210 may be pre-set to produce (fifty) 50 variant signatures of the originally received sample signature.

In some embodiments, when an audio signature is received in Operation 302, the apparatus 200 may be configured to perform (e.g., using the signature generation engine 208) one or more filtering processes to the audio signature. The filtering processes may be performed to ensure that the audio in the recording is clear (e.g., to remove any detected static or noise in the background of the audio). The filtering processes may also be performed any number of times at any stage from receipt of the audio signature to generating the predetermined number of variant signatures of the audio signatures. For example, the filtering processes may first be applied to the audio signature when the audio signature is obtained by the apparatus 200. Then, the filtering processes may additionally be applied to any or all of the predetermined number of variant signatures generated by the GAI model 210.

As shown by operation 306, the apparatus 200 includes means, such as processor 202, memory 204, communications hardware 206, or the like, for causing the predetermined number of variant signatures (e.g., the predetermined number of variant signatures generated in operation 304) to be presented to the individual (e.g., the individual who supplied the sample signature).

In particular, in some embodiments, the apparatus 200 may use the communications hardware 206 to transmit (e.g., using communications hardware 206) the predetermined number of variant signatures to a computing device (e.g., any of the computing devices 108A-108N shown in FIG. 1) of the individual. Alternative or in additionally, the signature generation engine 208 may also instruct communications hardware 206 to display the predetermined number of variant signatures on a peripheral display (e.g., a computer screen and/or monitor) connected to the apparatus 200.

In some embodiments, the predetermined number of variant signatures may be presented to the individual with a set of instructions for guiding the individual in selecting one or more of the predetermined number of variant signatures. In particular, the set of instructions may specify a number (e.g., any whole number larger than one (1) such as ten (10)) of variant signatures that the individual is supposed to select. The set of instructions may also instruct the individual to select across a broader range of variant signatures such that the selected ones of the variant signatures are not all too similar in nature. More specifically, this selection across the broader range advantageously creates a more diverse sample set that would be more difficult for a potential forger to identify and obtain.

As shown by operation 308, the apparatus 200 includes means, such as processor 202, memory 204, communications hardware 206, or the like, for receiving (e.g., via communications hardware 206) a selection from the individual. In some embodiments, the selection may include the predetermined number of variant signatures selected by the individual. The number of variant signatures selected by the individual may be equal to the number specified in the set of instructions for guiding the individual in selecting one or more of the predetermined number of variant signatures.

As shown by operation 310, the apparatus 200 includes means, such as processor 202, memory 204, communications hardware 206, or the like, for storing the selection received from the individual (e.g., the selection received in operation 308). In some embodiments, the selection may be stored in memory 204 of the apparatus (e.g., in a signature selection database configured in memory 204). Additionally or alternatively, the selection may be stored in external memory (e.g., in a signature selection database configured in the external memory) located on any external computing devices to the apparatus 200 (e.g., any of the computing devices 108A-108N of FIG. 1).

In some embodiments, the selection may be provided to the individual (e.g., via the apparatus 200) after the apparatus 200 receives and stores the selection. Additionally of alternatively, the selection may be consolidated and provided to the individual in a single file (or as separate files in a single folder) after the individual has finished the selection but before the selection is transmitted back to the apparatus 200 (e.g., received by the apparatus 200 in operation 308).

In some embodiments, the received selection may also be used by apparatus 200 to train the authentication engine 212. More specifically, the selection may be provided to authentication engine 212 to train the GAN model 214 of the authentication engine 212. In particular, the GAN model 214 may be any type of GAN model 214 that includes at least one generator and at least one discriminator. The authentication engine 212 provides the selection to the discriminator of the GAN model 214 to train the discriminator (to obtain a trained discriminator) using the provided selection. In some embodiments, the original sample signature may also be provided to train the discriminator. Such training allows the discriminator of the GAN model 214 to be aware of all the acceptable variations that the individual has selected.

In some embodiments, the authentication engine 212 may also use the selection to train the generator of the GAN model 214. In particular, the generator may be trained by using the selection as input data such that the generator is consistently generating (e.g., in the form of generating a set of synthetic signatures) identical ones or variations of (e.g., real or fake ones of) the inputted selection. The set of synthetic signatures generated by the generator are then fed into the trained discriminator for the trained discriminator to identify potential fraudulent signatures (e.g., signatures that do not match any of the variant signatures included in the selection (and the original sample selection)). The discriminator's output (e.g., the screening results of the discriminator) may be evaluated by a developer and/or admin of the GAN model 214 (e.g., as a human-in-the-loop element) to ensure the accuracy of the screening and selection performed by the trained discriminator. The evaluator's results may then be fed back into the trained discriminator to improve an accuracy of the trained discriminator's screenings for potentially fraudulent signatures.

In some embodiments, prior to (or as part of) training the generator and discriminator of the GAN model 214 using the selection, the authentication engine 212 may first parse (e.g., using any type of known pattern and feature recognition techniques) the predetermined number of variant signatures included in the selection to identify features and patterns within the one or more of the predetermined number of variant signatures included in the selection. These features and patterns identified by the authentication engine 212 may then be used (along with the selection itself) to train the generator and/or the discriminator of the GAN model 214.

As shown by operation 312, the apparatus 200 includes means, such as processor 202, memory 204, communications hardware 206, authentication engine 212, or the like, for authenticating subsequently received ones of the individual's signatures using the stored selection. Said another way, the stored selection is used to authenticate the individual when the individual is performing one or more requests (e.g., transaction request, log in requests, or the like) using the signature.

In some embodiments, the apparatus 200 may receive the request(s) from the individual. The request(s) may each include any type of information that is known to accompany such requests such as the individual's personal information, the nature of the request, or the like. The request may further include a signature provided by the individual for authenticating the request (herein referred to as a “request-authentication-use signature”).

In some embodiments, the apparatus 200 may authenticate (e.g., using authentication engine 212) the request-authentication-use signature by comparing the request-authentication-use signature to the selection (e.g., the variant signatures selected by the individual in between operations 306 and 308 that are stored in the signature selection database). In authenticating the request-authentication-use signature, the authentication engine 212 may permit (e.g., if the request-authentication-use signature matches any variant signatures in the selection within a predefined degree of likeness such as 95% (or any other percentage set by an administrator of the signature authentication manager 102) likeness) or reject (e.g., if the request-authentication-use signature falls under the predefined degree of likeness to all of the variant signatures in the selection) the request.

In some embodiments, such authentication of the request-authentication-use signature by the authentication engine 212 may also involve using the trained discriminator of the GAN model 214 to analyze and authenticate the request-authentication-use signature. In particular, the request-authentication-use signature would be input into the trained discriminator just like the set of synthetic signatures generated by the generator of the GAN model 214 for the trained discriminator to determine whether the request-authentication-use signature matches any of the variant signatures in the selection (and/or the sample signature) used to the train the discriminator.

In some embodiments, the request may be part of a multi-factor authentication process. In particular, the request may include (in addition to the request-authentication-use signature) a password and/or a digital certificate (or a digital copy of a certificate, such as an identification card (e.g., driver's license, passport, or the like)) of the individual. In such instances where the request is part of the multi-factor authentication process, the authentication engine 212 additionally verifies the authenticity of the password and/or the digital certificate. The request is only permitted if all parts of the multi-factor authentication are deemed authentic by the authentication engine 212.

In some embodiments, each time the apparatus 200 receives a request with a request-authentication-use signature, the apparatus 200 may store the received request-authentication-use signature in a request-authentication-use signature database (e.g., separate from the signature selection database in memory 204). After the apparatus 200 has received a predetermined number of request-authentication-use signatures in response to receiving multiple requests from the individual, the apparatus 200 may (via authentication engine 212) gather all the received request-authentication-use signatures associated with the predetermined number of requests and (e.g., using a combination of pattern and feature recognition techniques and one or more statistical models) determine a variance between the request-authentication-use signatures. This variance between the request-authentication-use signatures determined by the authentication engine 212 may further be used to train the trained discriminator such that the accuracy of the trained discriminator can advantageously be further improved to account for additional variances in the received request-authentication-use signatures.

FIG. 3 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

As described above, example embodiments provide methods and apparatuses that enable improved signature authentication. For example, by providing an individual with variant signatures generated (e.g., by artificial intelligence and machine learning) using a sample signature, the individual is able to determine which variations are acceptable for authenticating the individual. This way, the individual can intentionally use a different variation each time the individual submits a request such that a potential forger would find it difficult to forge the individual's signature given that the forger does not know that the variations are all acceptable. Using a GAN model to then authenticate any signatures accompanying an individual's requests also provides the technical advantage of being able to track all the variations selected by the individual. For example, if the individual selects a large number (e.g., more than 10 variations) it would be difficult (and almost impossible) for a human to cross check all variations against the provided signature, which in itself could also include slight variances caused by human error. Additionally, by removing the human element from the authentication process, the above-discussed limitations of existing fraud detection technologies can be avoided because a human's evaluation of two signatures would allow a higher degree of error (e.g., a higher degree of variance) to exist between the two signatures. Such allowance of a higher degree of error would be detrimental in certain transactions involving important materials (e.g., deed conveyance, transactions involving an individual's life savings, transactions involving a large sum of money, or the like).

As these examples all illustrate, example embodiments contemplated herein provide technical solutions that solve real-world problems faced during normal providing of signature authentication services. And while the current trend in technology allows a larger degree of error between two signatures (e.g., an existing reference signature and a signature accompanying a request), the inventors have found the importance of minimizing this larger degree of error and allowing the individual to establish a more unique identity. In particular, because the individual is the only person who knows about the selected variant signatures, the systems of one or more embodiments disclosed herein make it more difficult for forgers to pinpoint which signature to forge. As a result, one or more embodiments disclosed herein provide a direct improvement in the technical fields of fraud prevention, data security, and data authentication.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
obtaining, by a signature generation engine of a user authentication manager, a sample signature of an individual;
generating, by the signature generation engine, a predetermined number of variant signatures using the sample signature;
causing, by the signature generation engine, the predetermined number of variant signatures to be presented to the individual;
receiving, by an authentication engine, a selection from the individual, wherein the selection includes one or more of the predetermined number of variant signatures presented to the individual;
receiving, by the authentication engine, a request from the individual, wherein the request comprises a request-authentication-use signature;
authenticating, by the authentication engine, the individual by comparing the request-authentication-use signature to the selection; and
permitting or rejecting, by the authentication engine, the request based on a result of the authenticating.

2. The method of claim 1, wherein causing the predetermined number of variant signatures to be presented to the individual further comprises:
generating, by the signature generation engine, a first set of instructions for guiding the individual in selecting the one or more of the predetermined number of variant signatures.

3. The method of claim 2, further comprising:
causing, by the signature generation engine, transmission of a second set of instructions for guiding the individual in generating the sample signature.

4. The method of claim 1, wherein:
the request from the individual further comprises a digital certificate associated with the individual, and
authenticating the individual further comprises:
checking, by the authentication engine, the request for the digital certificate, and
verifying, by the authentication engine, an authenticity of the digital certificate.

5. The method of claim 1, wherein:
the authentication engine comprises a generative adversarial network (GAN) model comprising a generator and a discriminator, and
the method further comprises training, by the authentication engine, the discriminator using the selection to obtain a trained discriminator, wherein the request-authentication-use signature is authenticated using the trained discriminator.

6. The method of claim 5, wherein the method further comprises:
parsing, by the authentication engine, the one or more of the predetermined number of variant signatures included in the selection to identify features and patterns within the one or more of the predetermined number of variant signatures included in the selection;
training, by the authentication engine, the generator of the GAN using the features and patterns to obtain a trained generator;
causing, by the authentication engine, the trained generator to generate a set of synthetic signatures, wherein the set of synthetic signatures comprises real and fake ones of the request-authentication-use signature generated based on the features and patterns; and
further training, by the authentication engine, the trained discriminator using the set of synthetic signatures to improve an accuracy of the trained discriminator.

7. The method of claim 6, wherein the method further comprises, after receiving multiple ones of the request-authentication-use signature in response to receiving multiple requests from the individual:
parsing, by the authentication engine, the multiple ones of the request-authentication-use signature to identify one or more variations within the multiple ones of the request-authentication-use signature; and
training, by the authentication engine, the trained generator and trained discriminator using the one or more variations.

8. The method of claim 1, wherein:
the sample signature comprises at least one of a written signature, a voice signature, or a video signature, and
the selection is stored, by the authentication engine, in a signature selection database storing one or more instances of the selection.

9. The method of claim 8, wherein:
the request-authentication-use signature comprises at least the written signature and at least one of the voice signature or the video signature,
the request further comprises a digital certificate associated with the individual, and
authenticating the individual further comprises verifying an authenticity of the digital certificate in addition to comparing the request-authentication-use signature to a content of the signature selection database.

10. The method of claim 1, wherein predetermined number of variant signatures is fifty and the selection comprises ten of the predetermined number of variant signatures.

11. An apparatus comprising:
a signature generation engine configured to:
obtain a sample signature of an individual;
generate a predetermined number of variant signatures using the sample signature;
cause the predetermined number of variant signatures to be presented to the individual;
an authentication engine configured to:
receive a selection from the individual, wherein the selection includes one or more of the predetermined number of variant signatures presented to the individual;
receive a request from the individual, wherein the request comprises a request-authentication-use signature;
authenticate the individual by comparing the request-authentication-use signature to the selection; and
permit or reject the request based on a result of the authenticating.

12. The apparatus of claim 11, wherein causing the predetermined number of variant signatures to be presented to the individual further comprises:
generating, by the signature generation engine, a first set of instructions for guiding the individual in selecting the one or more of the predetermined number of variant signatures.

13. The apparatus of claim 12, wherein the signature generation engine is further configured to:
cause transmission of a second set of instructions for guiding the individual in generating the sample signature.

14. The apparatus of claim 11, wherein:
the request from the individual further comprises a digital certificate associated with the individual, and
authenticating the individual further comprises configuring the authentication engine to:
check the request for the digital certificate, and
verify an authenticity of the digital certificate.

15. The apparatus of claim 11, wherein:
the authentication engine comprises a generative adversarial network (GAN) model comprising a generator and a discriminator, and
the authentication engine is further configured to train the discriminator using the selection to obtain a trained discriminator, wherein the request-authentication-use signature is authenticated using the trained discriminator.

16. A computer program product comprising at least one non-transitory computer-readable storage medium storing software instructions that, when executed, cause an apparatus to:
obtain a sample signature of an individual;
generate a predetermined number of variant signatures using the sample signature;
cause the predetermined number of variant signatures to be presented to the individual;
receive a selection from the individual, wherein the selection includes one or more of the predetermined number of variant signatures presented to the individual;
receive a request from the individual, wherein the request comprises a request-authentication-use signature;
authenticate the individual by comparing the request-authentication-use signature to the selection; and
permit or reject the request based on a result of the authenticating.

17. The computer program product of claim 16, wherein causing the predetermined number of variant signatures to be presented to the individual further comprises:
generating a first set of instructions for guiding the individual in selecting the one or more of the predetermined number of variant signatures.

18. The computer program product of claim 17, wherein the apparatus is further caused to:
cause transmission of a second set of instructions for guiding the individual in generating the sample signature.

19. The computer program product of claim 16, wherein:
the request from the individual further comprises a digital certificate associated with the individual, and
authenticating the individual further comprises:
checking the request for the digital certificate, and
verifying an authenticity of the digital certificate.

20. The computer program product of claim 16, wherein:
the apparatus comprises a generative adversarial network (GAN) model comprising a generator and a discriminator, and
the apparatus is further caused to train the discriminator using the selection to obtain a trained discriminator, wherein the request-authentication-use signature is authenticated using the trained discriminator.
